(19) United States
(12) Patent Application Publication
(10) Pub. No.: US 2011/0203084 A1
(43) Pub. Date: Aug. 25, 2011

(54) METHOD OF MANUFACTURING PACKAGE, PIEZOELECTRIC VIBRATOR, OSCILLATOR, ELECTRONIC APPARATUS, AND RADIO-CONTROLLED TIMEPIECE

(76) Inventor: Yoichi Funabiki, Chiba-shi (JP)

(21) Appl. No.: 13/033,328

(22) Filed: Feb. 23, 2011

(30) Foreign Application Priority Data
Feb. 23, 2010 (JP) 2010-037985

(51) Int. Cl. H04R 17/00

(52) U.S. Cl. 29/25.35

(57) ABSTRACT

Provided are a method of manufacturing a package capable of forming a penetration electrode at a low cost without conduction defects while maintaining the airtightness of a cavity, a piezoelectric vibrator manufactured by the manufacturing method, and an oscillator, an electronic apparatus, and a radio-controlled timepiece each having the piezoelectric vibrator. In a glass frit application step, a glass frit is applied onto a first surface so that a first opening on the first surface side of a penetration hole is blocked under a depressurized atmosphere in a state where a second surface side of the penetration hole is blocked. In a glass frit filling step, an atmospheric pressure is increased so that the glass frit is filled in the penetration hole by a pressure difference which is generated between the inside of the penetration hole and the outside of the penetration hole.

### RELATED APPLICATIONS

This application claims priority under 35 U.S.C. §119 to Japanese Patent Application No. 2010-037985 filed on Feb. 23, 2010, the entire content of which is hereby incorporated by reference.

### BACKGROUND OF THE INVENTION

1. Field of the Invention

The present invention relates to a method of manufacturing a package, a piezoelectric vibrator, and an oscillator, an electronic apparatus, and a radio-controlled timepiece each having the piezoelectric vibrator.

2. Description of the Related Art

Recently, a piezoelectric vibrator utilizing quartz or the like has been used in cellular phones and portable information terminals as the time source, the timing source of a control signal, a reference signal source, and the like. Although there are various piezoelectric vibrators of this type, a two-layered surface mounted device-type piezoelectric vibrator is one known example thereof.

The piezoelectric vibrator of this type has a two-layered structure in which a first substrate and a second substrate are directly bonded and packaged, and a piezoelectric vibrating reed is accommodated in a cavity formed between the two substrates. As an example of such a two-layered piezoelectric vibrator, a piezoelectric vibrator in which piezoelectric vibrating reeds sealed in the inner side of a cavity and outer electrodes formed on the outer side of the base substrate are electrically connected by penetration electrodes formed on the base substrate is known (for example, see JP-A-2002-124845).

In the two-layered piezoelectric vibrator, the penetration electrodes perform two major roles of electrically connecting the piezoelectric vibrating reeds and the outer electrodes to each other and blocking the penetration holes to maintain the airtightness of the cavity. Particularly, if the adhesion between the penetration electrode and the penetration hole is not sufficient, there is a possibility that the airtightness of the cavity is impaired. In order to eliminate such an inconvenience, it is necessary to form the penetration electrode in a state where the penetration electrode is tightly and closely adhered to the inner circumferential surface of the penetration hole to completely block the penetration hole.

However, in JP-A-2002-124845, it is described that the penetration electrode is formed by using a pin member (corresponding to a metal pin of the present invention) made of a metal as a conductive member. As a specific method of forming the penetration electrode, it is described that after a base substrate wafer later serving as a base substrate is heated, the pin member is inserted into the penetration hole when the base substrate wafer is thermally softened.

However, according to the method of forming the penetration electrode by inserting the pin member into the penetration hole as disclosed in JP-A-2002-124845, it is difficult to completely block the gap between the pin member and the penetration hole. Therefore, there is a possibility that the airtightness of the cavity is not secured. Moreover, a number of penetration holes are formed in the base substrate wafer. Thus, a number of steps are required to insert the pin members into all penetration holes when the base substrate wafer is thermally softened.

In order to solve the above-described problem, a method of forming the penetration electrode using a conductive metal pin and a glass frit is proposed. As a specific penetration electrode forming method, first, a glass frit is filled into a gap between the penetration hole and the metal pin in a state where the metal pin standing from a flat plate-like base portion is inserted into the penetration hole (corresponding to a recess portion of the present invention). Moreover, after the filled glass frit is baked so that the penetration hole, the metal pin, and the glass frit are integrated with each other, the base portion is polished and removed, whereby the penetration electrode is formed.

However, in the above-described penetration electrode forming method, a glass frit filling step of filling a glass frit in the gap between the penetration hole and the metal pin is performed in the following manner.

FIGS. 19A and 19B are diagrams illustrating a glass frit filling step according to the related art.

In the glass frit filling step of the related art, as shown in FIG. 19A, first, a first squeegee 650a tilted at a small attack angle α (for example, about 15°) with respect to a base substrate wafer 40 is scanned along a first surface L so as to fill a glass frit 61 in a gap between a penetration hole 30 and a metal pin 7 (first filling step). At that time, the glass frit 61 is not filled on the rear surface side of the metal pin 7 in the scanning direction of the first squeegee, and a void D is formed. Subsequently, as shown in FIG. 19B, a second squeegee 650b is scanned in the opposite direction to the first squeegee 650a so as to fill the glass frit 61 in the void D (second filling step). In this way, in the glass frit filling step of the related art, by performing the first and second filling steps, the glass frit 61 is dispersed to the gap between the penetration hole 30 and the metal pin 7.

As described above, in the glass frit filling step of the related art, since the step of scanning the squeegee at least twice so as to fill the glass frit is required, the glass frit filling step is complicated.

Moreover, it is necessary to decrease the attack angle α while making the squeegee deformed in order to push the glass frit into the penetration hole using the squeegee. Therefore, in the glass frit filling step of the related art, it is necessary to use a special and expensive filling squeegee in which a tapered surface is formed on a surface on the moving direction side of the squeegee and a surface on the opposite side in the moving direction.

Moreover, since the scanning directions of the first and second squeegees are different, different squeegees are required in the first and second filling steps. Furthermore, since scanning of a plurality of squeegees must be realized in a screen printer, the mechanism of the screen printer is complicated, and the screen printer itself becomes expensive.

### SUMMARY OF THE INVENTION

It is therefore an object of the present invention to provide a method of manufacturing a package capable of forming a penetration electrode at a low cost, and to provide a piezoelectric vibrator manufactured by the manufacturing method, and an oscillator, an electronic apparatus, and a radio-controlled timepiece each having the piezoelectric vibrator.

According to an aspect of the present invention, there is provided a method of manufacturing a package capable of sealing an electronic component in a cavity which is formed between a plurality of substrates bonded to each other, the method including a penetration electrode forming step of forming a penetration electrode so as to penetrate a first substrate of the plurality of substrates in a thickness direction thereof so that the inner side of the cavity and the outer side of the package are electrically connected to each other. The penetration electrode forming step includes a recess forming step of forming a recess portion having a first opening on a first surface of the first substrate; a metal pin disposing step of inserting a metal pin into the recess portion; a glass frit application step of applying a glass frit onto the first surface; a glass frit filling step of filling the glass frit in a gap between an inner circumferential surface of the recess portion and an outer circumferential surface of the metal pin so as to seal the gap; a glass frit removal step of removing the glass frit remaining on the first surface; a baking step of baking and curing the glass frit filled in the recess portion; and a polishing step of polishing at least a second surface of the first substrate so as to expose the metal pin to the second surface. In the glass frit application step, the glass frit is applied onto the first surface so that the first opening on the first surface side of the recess portion is blocked under a depressurized atmosphere in a state where the second surface side of the recess portion is blocked. In the glass frit filling step, an atmospheric pressure is increased so that the glass frit is filled in the recess portion by a pressure difference which is generated between the inside of the recess portion and the outside of the recess portion.

According to this configuration, since the glass frit is filled using the pressure difference generated between the inside of the recess portion and the outside of the recess portion, it is possible to fill the glass frit without scanning the squeegee. Therefore, since the glass frit can be easily filled to every corner of the gap between the inner circumferential surface of the recess portion and the outer circumferential surface of the metal pin, it is possible to form the penetration electrode at a low cost. Moreover, since the occurrence of voids in the penetration electrode can be suppressed by filling the glass frit using the pressure difference, it is possible to maintain the airtightness of the cavity in a more favorable state compared to the related art.

It is preferable that the recess portion is a penetration hole, and the metal pin stands up in a normal direction from a flat plate-like base portion. It is also preferable that in the metal pin disposing step, the metal pin is inserted into the penetration hole from a second opening on the second surface side of the penetration hole so that the second opening is blocked by the base portion.

According to this configuration, since the second opening is blocked by the base portion, it is possible to seal the penetration hole to be maintained in a depressurized state and to generate a pressure difference between the inside of the penetration hole and the outside of the penetration hole. Therefore, even when the penetration hole is formed on the first substrate, it is possible to fill the glass frit in the penetration hole using the pressure difference similarly to the case of forming a bottomed recess portion. Moreover, since the metal pin can be disposed in a state where the base portion is in contact with the second surface, it is possible to prevent the metal pin from being tilted in the penetration hole.

It is preferable that the glass frit application step is performed by placing a mask configured to cover the peripheral portion of the first substrate and expose the central portion of the first substrate on the first surface and scanning a squeegee along the first surface while bringing the squeegee into contact with the mask.

According to this configuration, the glass frit is applied by scanning the squeegee while bringing the squeegee into contact with the mask. Therefore, in the glass frit application step, a layer of the glass frit having the same thickness as the mask can be formed on the central portion of the first substrate. Therefore, the glass frit can be applied so as to have a constant thickness. Moreover, by adjusting the thickness of the mask, the thickness of the layer of the glass frit in the glass frit application step can be easily adjusted.

It is preferable that at least a side surface in the moving direction of the squeegee has a single plane.

In the glass frit application step, it is only necessary to apply the glass frit so as to block the first opening on the first surface side, and it is not necessary to push the glass frit into the recess portion. Therefore, a squeegee having a special shape like a filling squeegee is not required, and a low-cost scribing squeegee in which the side surface in the moving direction of the squeegee has a single plane can be used. By using such a scribing squeegee, it is possible to form the penetration electrode at a low cost.

It is preferable that the glass frit removal step is performed by removing the mask so that the squeegee comes into contact with the first surface and scanning the squeegee along the first surface in the same direction as the scanning direction of the squeegee in the glass frit application step.

According to this configuration, since the scanning direction of the squeegee in the glass fit application step is the same as the scanning direction of the squeegee in the glass frit removal step, it is possible to simplify the mechanism of the screen printer. Therefore, it is possible to form the penetration electrode at a low cost.

According to another aspect of the present invention, there is provided a piezoelectric vibrator in which a piezoelectric vibrating reed is sealed in the cavity of the package manufactured by the package manufacturing method as the electronic component.

According to this configuration, since the piezoelectric vibrator is sealed in the package which is manufactured by a low-cost manufacturing method, a low-cost piezoelectric vibrator can be provided.

According to another aspect of the invention, there is provided an oscillator in which the above-described piezoelectric vibrator is electrically connected to an integrated circuit as an oscillating piece.

According to still another aspect of the invention, there is provided an electronic apparatus in which the above-described piezoelectric vibrator is electrically connected to a clock section.

According to still another aspect of the invention, there is provided a radio-controlled timepiece in which the above-described piezoelectric vibrator is electrically connected to a filter section.

Since each of the oscillator, electronic apparatus, and radio-controlled timepiece of the above aspects of the present invention includes the piezoelectric vibrator which is manufactured by a low-cost manufacturing method, an oscillator, an electronic apparatus, and a radio-controlled timepiece can be provided at a low cost.

According to this configuration, since the glass frit is filled using the pressure difference generated between the inside of the recess portion and the outside of the recess portion, it is possible to fill the glass frit without scanning the squeegee. Therefore, since the glass frit can be easily filled to every corner of the gap between the inner circumferential surface of the recess portion and the outer circumferential surface of the metal pin, it is possible to form the penetration electrode at a low cost. Moreover, since the occurrence of voids in the penetration electrode can be suppressed by filling the glass frit using the pressure difference, it is possible to maintain the airtightness of the cavity in a more favorable state compared to the related art.

### BRIEF DESCRIPTION OF THE DRAWINGS

FIG. 1 is a perspective view showing an external appearance of a piezoelectric vibrator according to an embodiment of the present invention.

FIG. 2 is a top view showing an inner structure of the piezoelectric vibrator shown in FIG. 1, showing a state where a lid substrate is removed.

FIG. 3 is a sectional view of the piezoelectric vibrator taken along the line A-A in FIG. 2.

FIG. 4 is an exploded perspective view of the piezoelectric vibrator shown in FIG. 1.

FIG. 5 is a top view of a piezoelectric vibrating reed.

FIG. 6 is a bottom view of the piezoelectric vibrating reed.

FIG. 7 is a sectional view taken along the line B-B in FIG. 5.

FIG. 8 is a flowchart of the manufacturing method of a piezoelectric vibrator.

FIG. 9 is an exploded perspective view of a wafer assembly.

FIG. 10 is a diagram illustrating a penetration hole.

FIGS. 11A and 11B are diagrams illustrating a metal pin, in which

FIG. 11A is a perspective view and FIG. 11B is a sectional view taken along the line C-C in FIG. 11A.

FIGS. 12A and 12B are diagrams illustrating a metal pin disposing step.

FIG. 13 is a diagram illustrating a glass frit application step.

FIG. 14 is a diagram illustrating a glass frit filling step.

FIG. 15 is a diagram illustrating a glass frit removal step.

FIG. 16 is a diagram showing the configuration of an oscillator according to an embodiment of the present invention.

FIG. 17 is a diagram showing the configuration of an electronic apparatus according to an embodiment of the present invention.

FIG. 18 is a diagram showing the configuration of a radio-controlled timepiece according to an embodiment of the present invention.

FIGS. 19A and 19B are diagrams illustrating a glass fit filling step according to the related art.

### DETAILED DESCRIPTION OF THE PREFERRED EMBODIMENTS

### First Embodiment

### Piezoelectric Vibrator

Hereinafter, a piezoelectric vibrator according to an embodiment of the present invention will be described with reference to the drawings.

In the following description, it is assumed that a first substrate is a base substrate, and a substrate bonded to the base substrate is a lid substrate. Moreover, it is assumed that an outer surface of the base substrate of a package (a piezoelectric vibrator) is a first surface L, and a bonding surface of the base substrate bonded to the lid substrate is a second surface U.

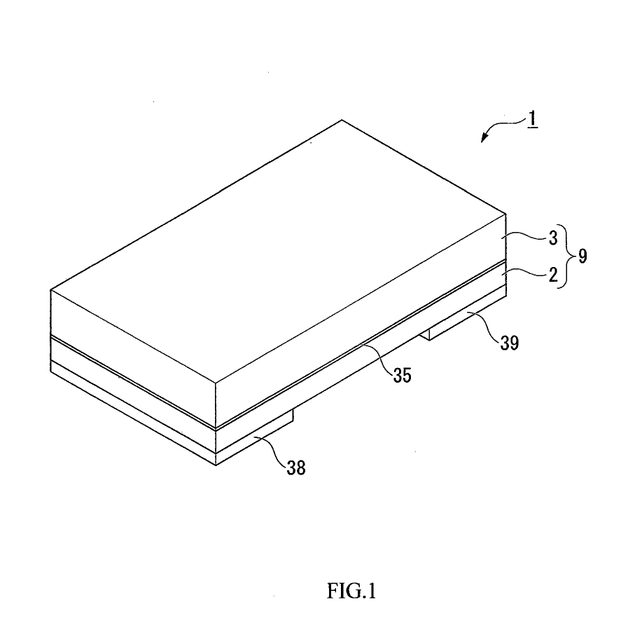

FIG. 1 is a perspective view showing an external appearance of a piezoelectric vibrator according to an embodiment of the present invention.

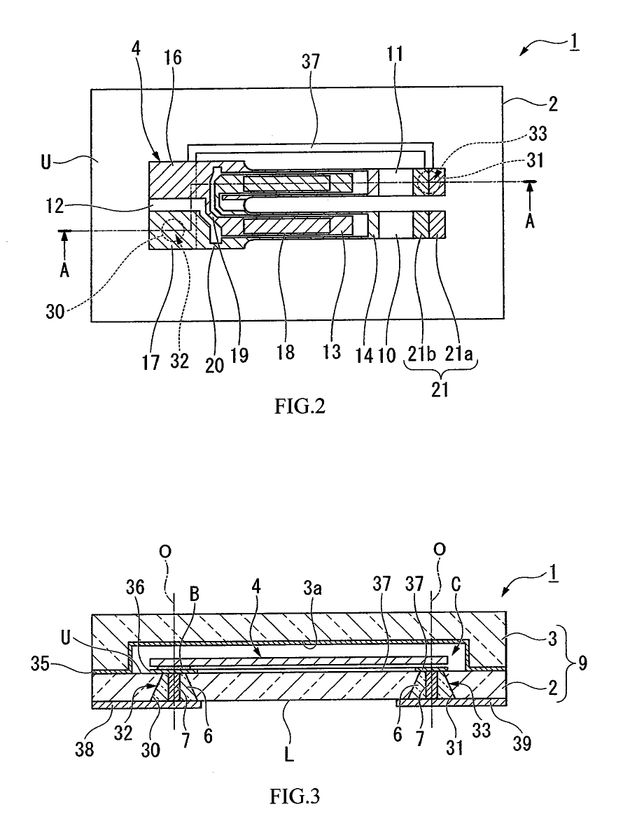

FIG. 2 is a top view showing an inner structure of the piezoelectric vibrator shown in FIG. 1, showing a state where a lid substrate is removed.

FIG. 3 is a sectional view of the piezoelectric vibrator taken along the line A-A in FIG. 2.

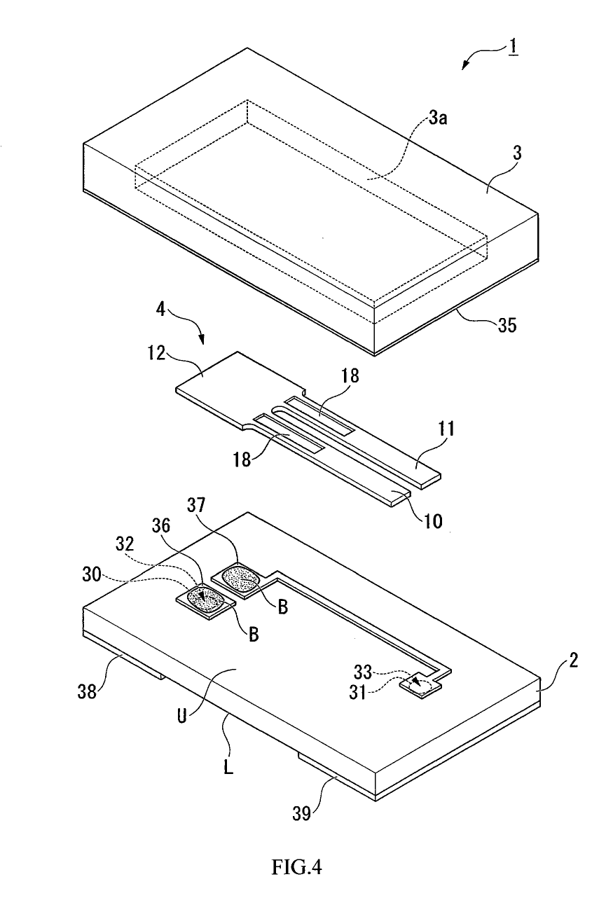

FIG. 4 is an exploded perspective view of the piezoelectric vibrator shown in FIG. 1.

In FIG. 4, for better understanding of the drawings, illustrations of the excitation electrode 15, extraction electrodes 19 and 20, mount electrodes 16 and 17, and weight metal film 21, which will be described later, are omitted.

As shown in FIGS. 1 to 4, a piezoelectric vibrator 1 according to the present embodiment is a surface mounted device-type piezoelectric vibrator 1 which includes a package 9, in which a base substrate 2 and a lid substrate 3 are anodically bonded to each other with a bonding film 35 disposed therebetween, and a piezoelectric vibrating reed 4 which is accommodated in a cavity C of the package 9.

### Piezoelectric Vibrating Reed

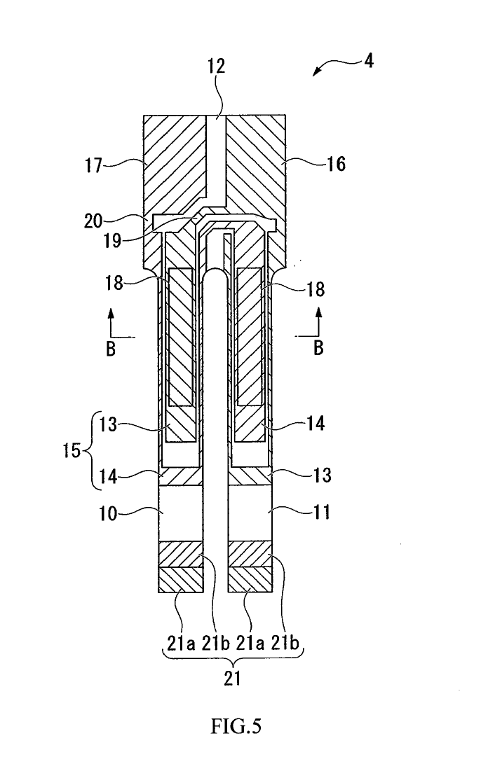

FIG. 5 is a top view of a piezoelectric vibrating reed.

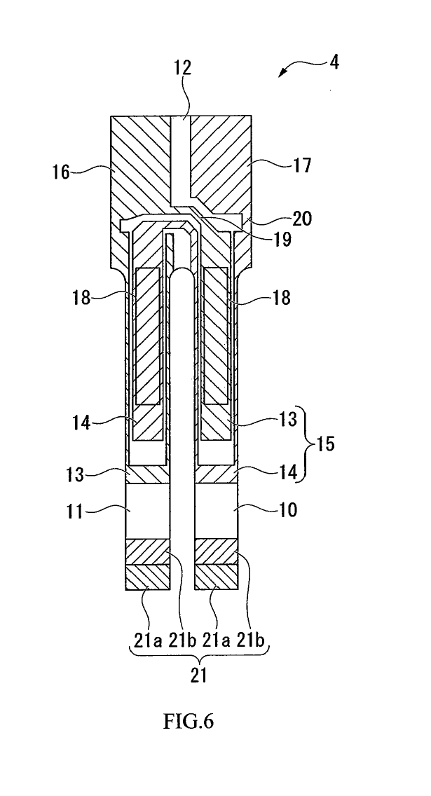

FIG. 6 is a bottom view of the piezoelectric vibrating reed.

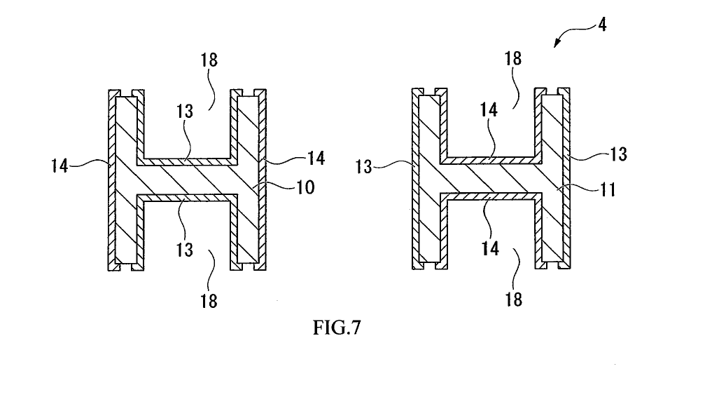

FIG. 7 is a sectional view taken along the line B-B in FIG. 5.

As shown in FIGS. 5 to 7, the piezoelectric vibrating reed 4 is a tuning-fork type vibrating reed which is made of a piezoelectric material such as crystal, lithium tantalate, or lithium niobate and is configured to vibrate when a predetermined voltage is applied thereto. The piezoelectric vibrating reed 4 includes a pair of vibrating arms 10 and 11 disposed in parallel to each other, a base portion 12 to which the base end sides of the pair of vibrating arms 10 and 11 are integrally fixed, and groove portions 18 which are formed on both principal surfaces of the pair of vibrating arms 10 and 11. The groove portions 18 are formed so as to extend from the base end sides of the vibrating arms 10 and 11 along the longitudinal direction of the vibrating arms 10 and 11 up to approximately the middle portions thereof.

The excitation electrode 15 and extraction electrodes 19 and 20 are formed by a single-layered film of chromium (Cr) which is the same material as the base layer of mount electrodes 16 and 17 described later. Therefore, it is possible to form the excitation electrode 15 and the extraction electrodes 19 and 20 at the same time as the forming of the base layer of the mount electrodes 16 and 17.

The excitation electrode 15 is an electrode that allows the pair of vibrating arms 10 and 11 to vibrate at a predetermined resonance frequency in a direction to move closer to or away from each other. The first excitation electrode 13 and second excitation electrode 14 that constitute the excitation electrode 15 are patterned and formed on the outer surfaces of the pair of vibrating arms 10 and 11 in an electrically isolated state.

The mount electrodes 16 and 17 of the present embodiment are laminated films of chromium (Cr) and gold (Au), which are formed by forming a chromium (Cr) film having good adhesion with quartz as a base layer and then forming a thin gold (Au) film on the surface thereof as a finishing layer.

The tip ends of the pair of the vibrating arms 10 and 11 are coated with a weight metal film 21 for adjustment (frequency tuning) of their own vibration states in a manner such as to vibrate within a predetermined frequency range. The weight metal film 21 is divided into a rough tuning film 21a used for tuning the frequency roughly and a fine tuning film 21b used for tuning the frequency finely. By tuning the frequency with the use of the rough tuning film 21a and the fine tuning film 21b, the frequency of the pair of the vibrating arms 10 and 11 can be set to fall within the range of the nominal frequency of the device.

### Package

As shown in FIGS. 1, 3, and 4, the base substrate 2 and the lid substrate 3 are substrates that can be anodically bonded and that are made of a glass material, for example, soda-lime glass, and are formed in a plate-like form. On a bonding surface side of the lid substrate 3 to be bonded to the base substrate 2, a recess portion 3a for a cavity is formed in which the piezoelectric vibrating reed 4 is accommodated.

A bonding film 35 for anodic bonding is formed on the entire surface on the bonding surface side of the lid substrate 3 to be bonded to the base substrate 2. That is to say, the bonding film 35 is formed in a frame region at the periphery of the recess portion 3a for the cavity in addition to the entire inner surface of the recess portion 3a for the cavity. Although the bonding film 35 of the present embodiment is made of a silicon film, the bonding film 35 may be made of aluminum (Al) or Cr. As will be described later, the bonding film 35 and the base substrate 2 are anodically bonded, whereby the cavity C is vacuum-sealed.

As shown in FIGS. 1, 3, and 4, the piezoelectric vibrator 1 includes penetration electrodes 32 and 33 which penetrate through the base substrate 2 in the thickness direction thereof so that the inside of the cavity C is electrically connected to the outside of the piezoelectric vibrator 1. Moreover, each of the penetration electrodes 32 and 33 has a metal pin 7 which is disposed in the penetration holes (recess portions) 30 and 31 penetrating through the base substrate 2 so as to electrically connect the piezoelectric vibrating reed 4 to the outside and a cylindrical member 6 which is filled between the penetration holes 30 and 31 and the metal pin 7.

As shown in FIGS. 2 and 3, the penetration holes 30 and 31 are formed so as to be received in the cavity C when the piezoelectric vibrator 1 is formed. More specifically, the penetration holes 30 and 31 of the present embodiment are formed such that one penetration hole 30 is positioned at a corresponding position close to the base portion 12 of the mounted piezoelectric vibrating reed 4 which is mounted in a mounting step described later, and the other penetration hole 31 is positioned at a corresponding position close to the tip end sides of the vibrating arms 10 and 11. As shown in FIG. 3, the penetration holes 30 and 31 of the present embodiment are formed so that the inner shape thereof gradually increases from the second surface U side towards the first surface L side and the cross section including the central axis O of the penetration holes 30 and 31 has a tapered shape. The tapering angle of the inner circumferential surfaces of the penetration holes 30 and 31 is about 10° to 20° with respect to the central axis O of the penetration holes 30 and 31. Moreover, in the present embodiment, the cross section in the direction perpendicular to the central axis O of the penetration holes 30 and 31 has a circular shape.

Next, the penetration electrode will be described. In the following description, although only the penetration electrode 32 is described, the same applies to the penetration electrode 33. Moreover, the same relationship between the penetration electrode 32, the lead-out electrode 36, and the outer electrode 39 applies to the relationship between the penetration electrode 33, the lead-out electrode 37, and the outer electrode 39.

As shown in FIG. 3, the penetration electrode 32 is formed by a metal pin 7 and a cylindrical member 6 which are disposed at the inner side of the penetration hole 30.

The metal pin 7 is a columnar member which has a diameter slightly smaller than the diameter on the second surface U side of the penetration hole 30 formed on the base substrate 2 and which has approximately the same length as the depth of the penetration hole 30.

The metal pin 7 is a conductive member formed of a metal material such as stainless steel, silver (Ag), Ni alloy, Al, and particularly, is preferably formed of an alloy (42 alloy) in which the iron (Fe) content is 58 wt % and the Ni content is 42 wt %. The metal pin 7 is formed by forging or press working.

In the present embodiment, the cylindrical member 6 is obtained by baking a glass frit in a glass frit baking step described later. The cylindrical member 6 has a shape of which both ends are flat and which has approximately the same thickness as the base substrate 2. The metal pin 7 is disposed at the center of the cylindrical member 6 so as to penetrate through the cylindrical member 6, and the cylindrical member 6 is tightly attached to the metal pin 7 and the penetration hole 30. In this way, the cylindrical member 6 and the metal pin 7 serve to maintain the airtightness of the cavity C by completely closing the penetration hole 30 and also to make a lead-out electrode 36 and an outer electrode 38 described later electrically connected to each other.

As shown in FIGS. 2 to 4, a pair of lead-out electrodes 36 and 37 is patterned on the second surface U side of the base substrate 2. One lead-out electrode 36 among the pair of lead-out electrodes 36 and 37 is formed so as to be disposed right above one penetration electrode 32. Moreover, the other lead-out electrode 37 is formed so as to be disposed right above the other penetration electrode 33 after being led out from a position near one lead-out electrode 36 towards the tip end sides of the vibrating arms 10 and 11 along the vibrating arms 10 and 11.

Moreover, bumps B which have a tapered shape and are made from Au or the like are formed on the pair of lead-out electrodes 36 and 37, and the pair of mount electrodes of the piezoelectric vibrating reed 4 is mounted using the bumps B. In this way, one mount electrode 16 of the piezoelectric vibrating reed 4 is electrically connected to one penetration electrode 32 via one lead-out electrode 36, and the other mount electrode 17 is electrically connected to the other penetration electrode 33 via the other lead-out electrode 37.

Moreover, as shown in FIGS. 1, 3, and 4, a pair of outer electrodes 38 and 39 is formed on the first surface L of the base substrate 2. The pair of outer electrodes 38 and 39 is formed at both ends in the longitudinal direction of the base substrate 2 and is electrically connected to the pair of penetration electrodes 32 and 33, respectively.

When the piezoelectric vibrator 1 configured in this manner is operated, a predetermined drive voltage is applied to the outer electrodes 38 and 39 formed on the base substrate 2. In this way, a voltage can be applied to the excitation electrode 15 including the first and second excitation electrodes 13 and 14, of the piezoelectric vibrating reed 4, and the pair of vibrating arms 10 and 11 is allowed to vibrate at a predetermined frequency in a direction moving closer to or away from each other. This vibration of the pair of vibrating arms 10 and 11 can be used as the time source, the timing source of a control signal, the reference signal source, and the like.

### Piezoelectric Vibrator Manufacturing Method

Next, a method of manufacturing the above-described piezoelectric vibrator will be described with reference to a flowchart.

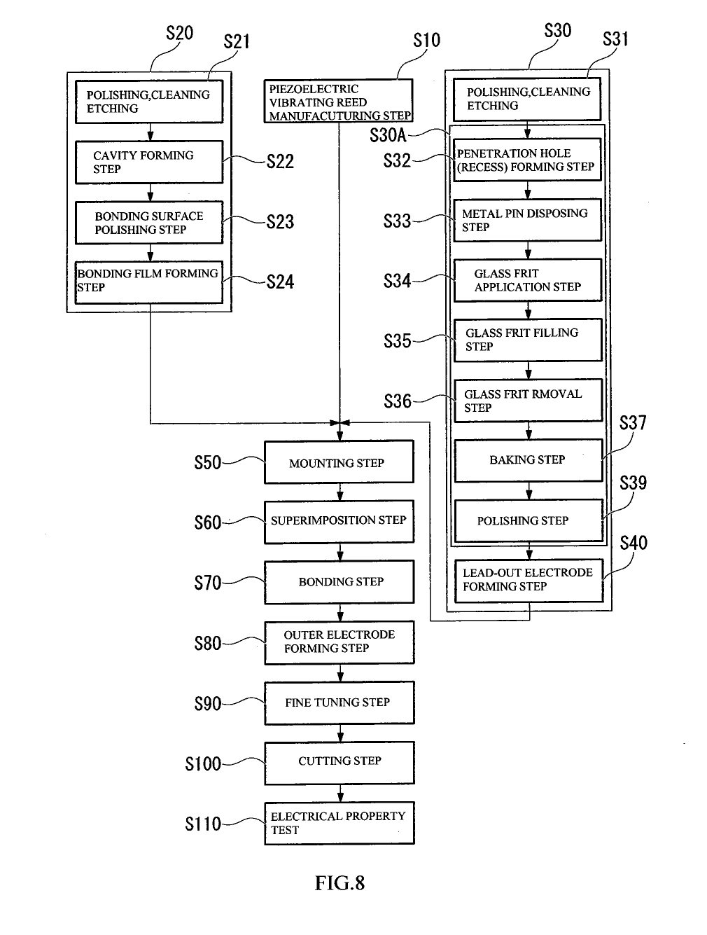

FIG. 8 is a flowchart of the manufacturing method of a piezoelectric vibrator according to the present embodiment.

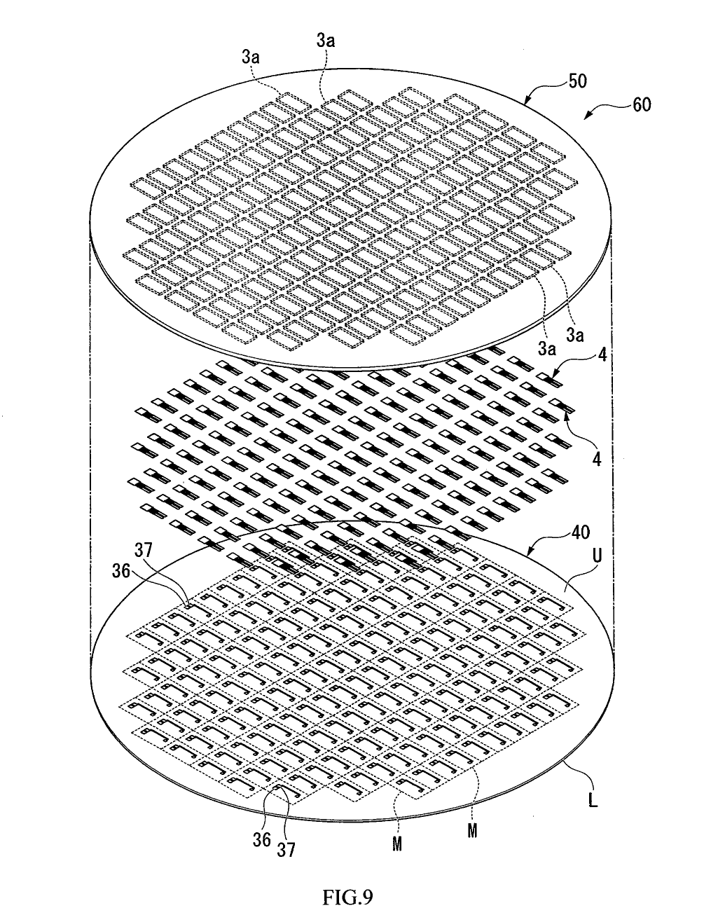

FIG. 9 is an exploded perspective view of a wafer assembly. The dotted line shown in FIG. 9 is a cutting line M along which a cutting step performed later is achieved.

The manufacturing method of the piezoelectric vibrator according to the present embodiment mainly includes a piezoelectric vibrating reed manufacturing step S10, a lid substrate wafer manufacturing step S20, a base substrate wafer manufacturing step S30, and an assembling step (S50 and subsequent steps). Among these steps, the piezoelectric vibrating reed manufacturing step S10, the lid substrate wafer manufacturing step S20, and the base substrate wafer manufacturing step S30 can be performed in parallel.

### Piezoelectric Vibrating Reed Manufacturing Step

In the piezoelectric vibrating reed manufacturing step S10, the piezoelectric vibrating reed 4 shown in FIGS. 5 to 7 is manufactured. Specifically, first, a rough Lambert crystal is sliced at a predetermined angle to obtain a wafer having a constant thickness. Subsequently, the wafer is subjected to crude processing by lapping, and an affected layer is removed by etching. Then, the wafer is subjected to mirror processing such as polishing to obtain a wafer having a predetermined thickness. Subsequently, the wafer is subjected to appropriate processing such as washing, and the wafer is patterned so as to have the outer shape of the piezoelectric vibrating reed 4 by a photolithography technique. Moreover, a metal film is formed and patterned on the wafer, thus forming the excitation electrode 15, the extraction electrodes 19 and 20, the mount electrodes 16 and 17, and the weight metal film 21. In this way, a plurality of piezoelectric vibrating reeds 4 can be manufactured. Subsequently, rough tuning of the resonance frequency of the piezoelectric vibrating reed 4 is performed. This rough tuning is achieved by irradiating the rough tuning film 21a of the weight metal film 21 with a laser beam to evaporate a part of the rough tuning film 21a, thus changing the weight of the vibrating arms 10 and 11.

### Lid Substrate Wafer Manufacturing Step

In the lid substrate wafer manufacturing step S20, as shown in FIG. 10, the lid substrate wafer 50 later serving as the lid substrate 3 is manufactured. First, a disk-shaped lid substrate wafer 50 made of a soda-lime glass is polished to a predetermined thickness and cleaned, and then, the affected uppermost layer is removed by etching or the like (S21). Subsequently, in a cavity forming step S22, a plurality of recess portions 3a for cavities is formed on a bonding surface of the lid substrate wafer 50 to be bonded to the base substrate wafer 40. The recess portions 3a for cavities are formed by heat-press molding, etching, or the like. After that, in a bonding surface polishing step S23, the bonding surface bonded to the base substrate wafer 40 is polished.

Subsequently, in a bonding film forming step S24, a bonding film 35 shown in FIGS. 1, 2, and 4 is formed on the bonding surface to be bonded to the base substrate wafer 40. The bonding film 35 may be formed on the entire inner surface of the cavity C in addition to the bonding surface to be bonded to the base substrate wafer 40. In this way, patterning of the bonding film 35 is not necessary, and the manufacturing cost can be reduced. The bonding film 35 can be formed by a film-formation method such as sputtering or CVD. Since the bonding surface polishing step S23 is performed before the bonding film forming step S24, the flatness of the surface of the bonding film 35 can be secured, and stable bonding with the base substrate wafer 40 can be achieved.

### Base Substrate Wafer Manufacturing Step

In a base substrate wafer manufacturing step S30, as shown in FIG. 9, the base substrate wafer 40 later serving as the base substrate 2 is manufactured. First, a disk-shaped base substrate wafer 40 made of a soda-lime glass is polished to a predetermined thickness and cleaned, and then, the affected uppermost layer is removed by etching or the like (S31).

### Penetration Electrode Forming Step

Subsequently, a penetration electrode forming step S30A is performed in which the pair of penetration electrodes 32 and 33 is formed on the base substrate wafer 40. Hereinafter, the penetration electrode forming step S30A will be described. In the following description, although only the step of forming the penetration electrode 32 is described, the same applies to the step of forming the penetration electrode 33.

As shown in FIG. 8, the penetration electrode forming step S30A of the present embodiment includes a penetration hole (a recess portion) forming step S32 of forming a penetration hole (a recess portion) having a first opening on the first surface of the base substrate wafer 40 and a metal pin disposing step S33 of inserting a metal pin into the penetration hole. The penetration electrode forming step S30A also includes a glass frit application step S34 of applying a glass frit onto the first surface, a glass frit filling step S35 of filling the glass frit in the gap between the inner circumferential surface of the penetration hole and the outer circumferential surface of the metal pin so as to seal the gap, and a glass fit removal step S36 of removing the glass frit remaining on the first surface. The penetration electrode forming step S30A also includes a baking step S37 of baking and curing the glass frit filled in the penetration hole, and a polishing step S39 of polishing at least the second surface of the base substrate wafer so that the metal pin is exposed to the second surface.

### Penetration Hole Forming Step

FIG. 10 is a diagram illustrating a penetration hole.

In the penetration electrode forming step S30A, a penetration hole forming step S32 is performed in which the penetration hole 30 is formed in the base substrate wafer 40 so as to dispose a penetration electrode. The penetration hole 30 is formed by press working, a sand blast method, and the like. In the present embodiment, as shown in FIG. 10, the penetration hole 30 is formed by press working so that the inner shape thereof gradually increases from the second surface U side of the base substrate wafer 40 towards the first surface L side.

As the specific penetration hole forming step S32, first, a press mold is heated and pressed against the first surface L of the base substrate wafer 40. Here, a bowl-shaped recess portion is formed on the base substrate wafer 40 by a truncated conical projection formed on the press mold. After that, the second surface U of the base substrate wafer 40 is polished to remove the bottom surface of the recess portion, whereby the penetration hole 30 having a tapered inner surface is formed. In this way, the penetration hole forming step S32 ends.

In the present embodiment, although the cross section of the penetration hole 30 in the direction perpendicular to the central axis O has a circular shape, the cross section may have a rectangular shape, for example, by changing the shape of the projection on the press mold.

### Metal Pin Disposing Step

Subsequently, a metal pin disposing step S33 is performed in which a metal pin is inserted into the penetration hole 30.

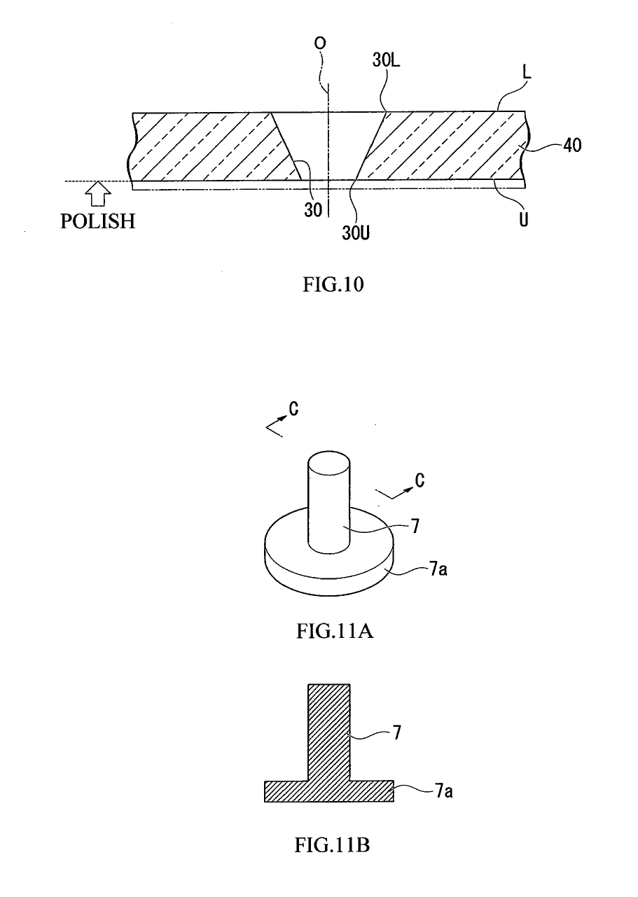

FIGS. 11A and 11B are diagrams illustrating a metal pin, in which FIG. 11A is a perspective view and FIG. 11B is a sectional view taken along the line C-C in FIG. 11A.

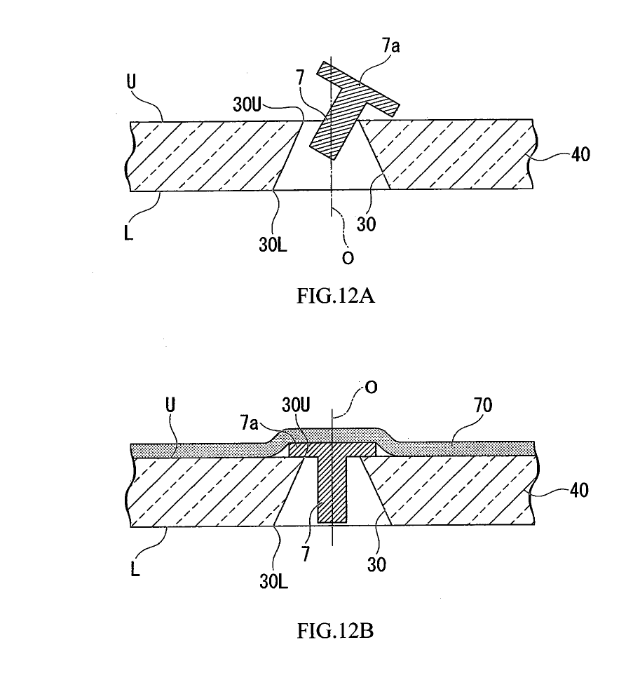

FIGS. 12A and 12B are diagrams illustrating a metal pin disposing step, in which FIG. 12A shows a state during the disposing and FIG. 12B shows a state after the disposing.

As shown in FIGS. 11A and 11B, a rivet member is formed by a metal pin 7 and a base portion 7a. The metal pin 7 stands up in a normal direction from the flat plate-like base portion 7a. When the metal pin 7 and the base portion 7a are formed, first, a rod-like member having the same diameter as the metal pin 7 is cut. After that, one end side of the rod-like member is processed by press working or forging to form the base portion 7a, and the other end side is cut, whereby the metal pin 7 is formed. In the present embodiment, the base portion 7a has an approximately disk-like shape. Moreover, the outer shape in top view of the base portion 7a is larger than the outer shape in top view of the metal pin 7 and is larger than the outer shape in top view of a second opening 30U. In this way, the metal pin 7 and the base portion 7a are formed.

In the metal pin disposing step S33, as shown in FIGS. 12A and 12B, the metal pin 7 is inserted from the second opening 30U of the base substrate wafer 40 so that the metal pin 7 is disposed in the penetration hole 30. As a specific metal pin disposing method, for example, a metal pin group is disposed on the second surface U of the base substrate wafer 40. Moreover, vibration is applied to the base substrate wafer 40 while shaking the base substrate wafer 40 to disperse the metal pin group, whereby the metal pin 7 is inserted into the penetration hole 30. The metal pin 7 may be disposed in the penetration hole 30 by disposing a plurality of metal pins 7 at positions corresponding to the penetration holes 30 using a jig and inserting the plurality of metal pins 7 from the second surface U side. Moreover, as shown in FIG. 12B, in the metal pin disposing step S33, the base portion 7a is disposed in a state of being in contact with the second surface U of the base substrate wafer 40 with the base portion 7a blocking the second opening 30U.

After the metal pin 7 is disposed in the penetration hole 30, as shown in FIG. 12B, a laminate material 70 made of a paper tape is bonded to the second surface U side. In this way, it is possible to completely block the second opening 30U with the base portion 7a. Therefore, by increasing the atmospheric pressure after the glass frit is applied onto the first surface L in a glass frit application step S34 described later, it is possible to generate a pressure difference between the inside of the penetration hole 30 and the outside of the penetration hole 30. Moreover, it is possible to prevent falling of the metal pin 7 or leakage of the glass frit. In this way, the metal pin disposing step S33 ends. After the laminate material 70 is bonded, the base substrate wafer 40 is turned upside down so that the first surface L side becomes the upper surface, and a glass frit application step S34 described later is performed.

### Glass Frit Application Step

Subsequently, the glass frit application step S34 is performed.

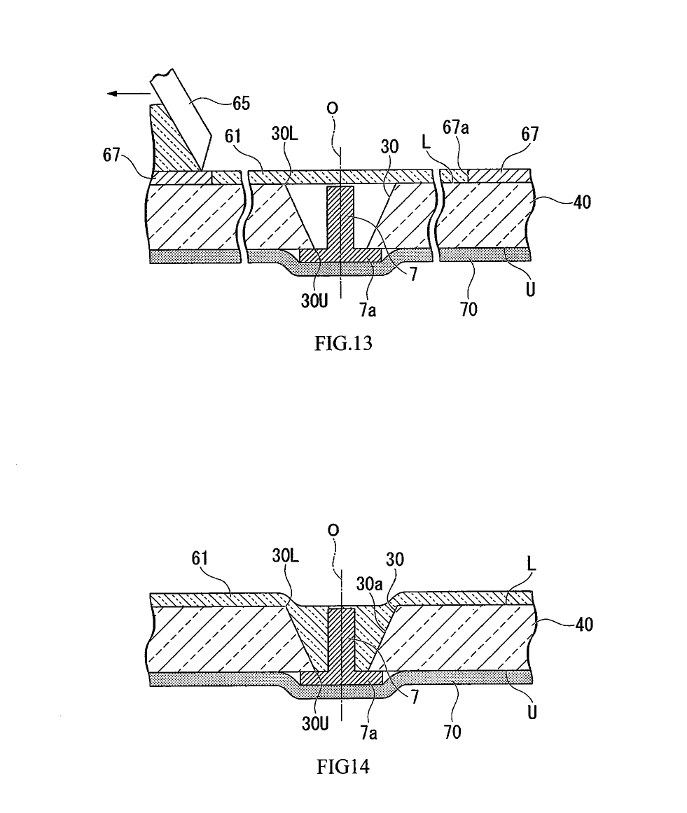

FIG. 13 is a diagram illustrating the glass frit application step S34.

In the glass frit application step S34, by scanning a squeegee 65, a glass frit is applied from the first surface L side so that a first opening 30L on the first surface L side of the penetration hole 30 is blocked.

The squeegee 65 is a plate-like member made of a flexible rubber material such as urethane rubber. The squeegee 65 is a so-called scribing squeegee. The scribing squeegee is formed so that a side surface in the moving direction of the squeegee has a single plane, and a tapered surface tilted so that the squeegee has a tapered shape is formed on the opposite surface.

The squeegee 65 is set on a screen printer not shown. Here, the squeegee 65 is set on the screen printer so that the angle (attack angle) between the squeegee 65 and the base substrate wafer 40 when scanning the squeegee 65 becomes about 60° to 70°. Since a tapered surface is formed on the surface on the opposite side in the moving direction, the tip end of the squeegee 65 can be freely bent and deformed.

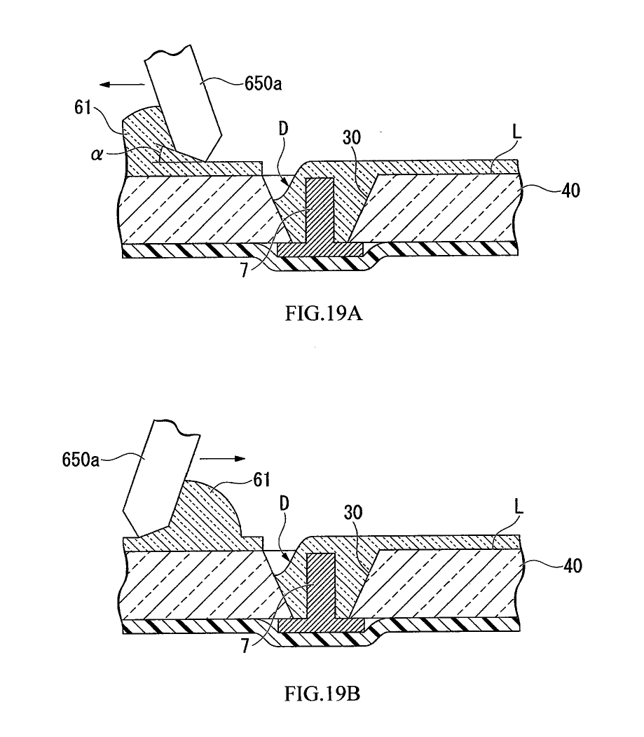

In the glass frit application step S34, the glass frit 61 is applied so as to block the first opening 30L of the penetration hole 30. Therefore, since it is not necessary to push the glass frit 61 into the penetration hole 30, it is not necessary to decrease the attack angle of the squeegee. Therefore, a special filling squeegee (see FIGS. 19A and 19B) in which both the surface on the moving direction side and the surface on the opposite side in the moving direction have tapered surfaces is not required in the glass frit application step S34, but a low-cost scribing squeegee can be used.

As a specific glass frit application step S34, first, a mask 67 is placed on the first surface L side. The mask 67 of the present embodiment is a flat plate-like member made of metal such as a stainless steel having a thickness of about 0.1 mm to 0.2 mm and is formed by press working or the like. The mask 67 is configured to cover the peripheral portion of the base substrate wafer 40 and has an opening 67a that exposes the central portion of the base substrate wafer 40. By covering the peripheral portion of the base substrate wafer 40, it is possible to prevent the glass frit from curving its way to adhere onto the second surface U.

Subsequently, the base substrate wafer 40 is transferred and set in a chamber (not shown) of a screen printer (not shown), and the inside of the chamber is depressurized to create a depressurized atmosphere. After that, under a depressurized atmosphere, the glass frit 61 is applied onto the first surface L side of the base substrate wafer 40 by scanning the squeegee 65 along the first surface L on the mask 67 while bringing the tip end of the squeegee 65 into contact with the surface of the mask 67. In this way, as shown in FIG. 13, a layer of the glass frit 61 having the same thickness (about 0.1 mm to 0.2 mm) as the mask 67 can be formed on the first surface L. By changing the thickness of the mask, the thickness of the layer of the glass frit in the glass frit application step S34 can be easily changed. In this way, the glass frit application step S34 ends.

### Glass Frit Filling Step

Subsequently, a glass fit filling step S35 is performed.

FIG. 14 is a diagram illustrating the glass frit filling step S35.

In the glass frit application step, the glass frit 61 is filled in the gap between the inner circumferential surface 30a of the penetration hole 30 and the outer circumferential surface of the metal pin 7. The glass frit filling step S35 may be performed in a state where the mask is placed on the first surface L and may be performed after the mask is removed from the first surface L.

As a specific glass frit filling step S35, the inner pressure of the chamber is increased, for example by making the inside of the chamber open to the atmosphere. In this way, a pressure difference is generated between the inside of the penetration hole 30 and the outside of the penetration hole 30. Moreover, as shown in FIG. 14, the glass frit 61 which has been formed as a layer on the penetration hole 30 is pushed into the penetration hole 30. As described above, since the glass frit 61 is filled using the pressure difference generated between the inside of the penetration hole 30 and the outside of the penetration hole 30, it is possible to reliably fill the glass frit 61 to every corner of the gap between the inner circumferential surface 30a of the penetration hole 30 and the outer circumferential surface of the metal pin 7.

### Glass Frit Removal Step

Subsequently, a glass frit removal step S36 is performed.

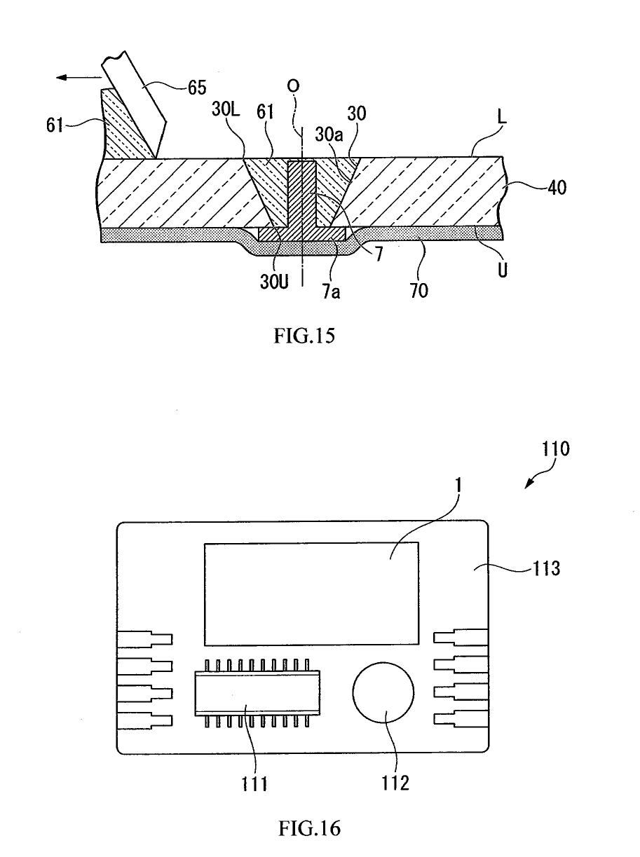

FIG. 15 is a diagram illustrating the glass frit removal step S36.

In the glass frit removal step S36, the redundant glass frit 61 remaining on the first surface L is removed. The glass frit removal step S36 is performed after the mask is removed from the first surface.

As a specific glass frit removal step S36, the squeegee 65 is moved along the first surface L while bringing the tip end of the squeegee 65 into contact with the first surface L of the base substrate wafer 40. In this way, the glass frit 61 is moved, pushed, and removed by the tip end of the squeegee 65.

In the glass frit removal step S36, the squeegee 65 is scanned in the same direction as in the glass frit application step S34. Therefore, as compared to the case of scanning the squeegee 65 in different directions, it is possible to simplify the mechanism of the screen printer since it is not necessary to configure the screen printer so that the squeegee can be scanned in a plurality of directions. Moreover, the attack surface of the squeegee used in the glass frit removal step S36 is formed on the moving direction side similarly to the squeegee used in the glass frit application step S34. Therefore, as for the squeegee 65 used in the glass frit removal step S36, a low-cost scribing squeegee which is the same as the squeegee used in the glass frit application step S34 can be used.

After that, the glass frit 61 is temporarily dried and solidified. For example, after the base substrate wafer 40 is transferred into a chamber maintained at a constant temperature, by maintaining the base substrate wafer 40 under an atmosphere of about 85° C. for about 30 minutes, the glass frit 61 is temporarily dried. When the glass frit 61 is temporarily dried, the glass frit 61 is solidified, and the metal pin 7 and the penetration hole 30 are attached to the glass frit 61. Therefore, even when the laminate material 70 is removed from the second surface, the metal pin 7 will not fall off. Finally, if necessary, the residues of the redundant glass frit 61 adhering on the first surface L of the base substrate wafer 40 are removed. In this way, the glass frit removal step S36 ends.

### Baking Step

Subsequently, a baking step S37 is performed in which the glass frit filled into the penetration hole is baked and cured. For example, after the base substrate wafer is transferred to a baking furnace, the base substrate wafer is maintained under an atmosphere of about 610° C. for about 30 minutes. After that, the base substrate wafer 40 is maintained under a room-temperature atmosphere and cooled. As a result, the glass frit is cured to form a cylindrical member, and the penetration hole 30, a cylindrical member 6, and the metal pin 7 are attached to each other, whereby the penetration electrode 32 (see FIG. 3) can be formed. In this way, the baking step S37 ends.

### Polishing Step

Subsequently, a polishing step S39 is performed in which at least the second surface U of the base substrate wafer 40 is polished so as to expose the metal pin 7 to the second surface U. By polishing the second surface U, it is possible to remove the base portion 7a and allow the metal pin 7 to remain inside the cylindrical member 6 as shown in FIG. 3. Moreover, by polishing the first surface L, it is possible to make the first surface L flat and expose the tip end of the metal pin 7. As a result, it is possible to make the surface of the base substrate wafer 40 approximately flush with both ends of the metal pin 7 and obtain a plurality of pairs of penetration electrodes 32. The penetration electrode forming step S30A ends at a point in time when the polishing step S39 is performed.

After that, returning to FIG. 9, a lead-out electrode forming step S40 is performed in which a plurality of lead-out electrodes 36 and 37 is formed on the second surface U so as to be electrically connected to the penetration electrodes, respectively. In addition, tapered bumps made of Au or the like are formed on the lead-out electrodes 36 and 37. In FIG. 9, illustrations of the bumps are omitted to make the drawing easier to see. The base substrate wafer manufacturing step S30 ends at this point in time.

### Piezoelectric Vibrator Assembling Step Subsequent to Mounting Step S50

Subsequently, a mounting step S50 is performed in which the piezoelectric vibrating reeds 4 are bonded to the lead-out electrodes 36 and 37 of the base substrate wafer 40 by the bumps B. Specifically, the base portions 12 of the piezoelectric vibrating reeds 4 are placed on the bumps B, and an ultrasonic vibration is applied while pressing the piezoelectric vibrating reeds 4 against the bumps B and heating the bumps B to a predetermined temperature. In this way, as shown in FIG. 3, the base portions 12 are mechanically fixed to the bumps B in a state where the vibrating arms 10 and 11 of the piezoelectric vibrating reed 4 are floated from the second surface U of the base substrate wafer 40. Moreover, the mount electrodes 16 and 17 are electrically connected to the lead-out electrodes 36 and 37.

After the mounting of the piezoelectric vibrating reed 4 is completed, as shown in FIG. 9, a superimposition step S60 is performed in which the lid substrate wafer 50 is superimposed onto the base substrate wafer 40. Specifically, the two wafers 40 and 50 are aligned at a correct position using reference marks (not shown) or the like as indices. In this way, the piezoelectric vibrating reed 4 mounted on the base substrate wafer 40 is accommodated in the cavity C which is surrounded by the recess portion 3a for cavities of the lid substrate wafer 50 and the base substrate wafer 40.

After the superimposition step S60 is performed, a bonding step S70 is performed in which the two superimposed wafers 40 and 50 are inserted into an anodic bonding machine (not shown) to achieve anodic bonding under a predetermined temperature atmosphere with application of a predetermined voltage. Specifically, a predetermined voltage is applied between the bonding film 35 and the base substrate wafer 40. Then, an electrochemical reaction occurs at an interface between the bonding film 35 and the base substrate wafer 40, whereby they are closely and tightly adhered and anodically bonded. In this way, the piezoelectric vibrating reed 4 can be sealed in the cavity C, and a wafer assembly 60 in which the base substrate wafer 40 and the lid substrate wafer 50 are bonded to each other can be obtained as shown in FIG. 9. In FIG. 9, for better understanding of the drawing, the wafer assembly 60 is illustrated in an exploded state, and illustration of the bonding film 35 is omitted from the lid substrate wafer 50.

Subsequently, an outer electrode forming step S80 is performed in which a conductive material is patterned onto the first surface L of the base substrate wafer 40 so as to form a plurality of pairs of outer electrodes 38 and 39 (see FIG. 3) which is electrically connected to the pair of penetration electrodes 32 and 33. Through this step, the piezoelectric vibrating reed 4 is electrically connected to the outer electrodes 38 and 39 through the penetration electrodes 32 and 33.

Subsequently, a fine tuning step S90 is performed on the wafer assembly 60 where the frequencies of the individual piezoelectric vibrators sealed in the cavities C are tuned finely to fall within a predetermined range. Specifically, a predetermined voltage is continuously applied to the outer electrodes 38 and 39 shown in FIG. 4 to allow the piezoelectric vibrating reeds 4 to vibrate, and the vibration frequency is measured. In this state, a laser beam is irradiated onto the base substrate wafer 40 from the outer side so as to evaporate the fine tuning film 21b of the weight metal film 21 shown in FIGS. 5 and 6. In this way, since the weight on the tip end sides of the pair of vibrating arms 10 and 11 decreases, the frequency of the piezoelectric vibrating reed 4 increases. By so doing, the frequency of the piezoelectric vibrator can be finely tuned so as to fall within the range of the nominal frequency.

After the fine tuning of the frequency is completed, a cutting step S100 is performed in which the bonded wafer assembly 60 is cut along the cutting line M shown in FIG. 9. Specifically, first, a UV tape is attached on the surface of the base substrate wafer 40 of the wafer assembly 60. Subsequently, a laser beam is irradiated along the cutting line M from the side of the lid substrate wafer 50 (scribing). Subsequently, the wafer assembly 60 is divided and cut along the cutting line M by a cutting blade pressing against the surface of the UV tape (breaking). After that, the UV tape is separated by irradiation of UV light. In this way, it is possible to divide the wafer assembly 60 into a plurality of piezoelectric vibrators. The wafer assembly 60 may be cut by other methods such as dicing.

Moreover, the fine tuning step S90 may be performed after cutting the wafer assembly into pieces of individual piezoelectric vibrators in the cutting step S100. However, as described above, the fine tuning can be performed in a state of the wafer assembly 60 by performing the fine tuning step S90 first. Therefore, in the case of performing the fine tuning step S90 first, a plurality of piezoelectric vibrators can be finely tuned more efficiently. This is preferable since the throughput can be improved.

Then, an inner electrical property test S110 is performed. That is, resonance frequency, resonant resistance value, drive level characteristics (exciting power dependency of resonance frequency and resonant resistance value), and the like of the piezoelectric vibrating reed 4 are checked by measurement. Moreover, an insulation resistance characteristic and the like are checked together. Finally, visual inspection of the piezoelectric vibrator is performed to finally check the dimension, quality, and the like. Thus, the manufacturing of the piezoelectric vibrator ends.

According to the present embodiment, as shown in FIG. 14, since the glass frit 61 is filled using the pressure difference generated between the inside of the penetration hole 30 and the outside of the penetration hole 30, it is possible to fill the glass frit 61 without scanning the squeegee. Therefore, since the glass frit 61 can be easily filled to every corner of the gap between the inner circumferential surface 30a of the penetration hole 30 and the outer circumferential surface of the metal pin 7, it is possible to form the penetration electrode at a low cost. Moreover, since the occurrence of voids in the penetration electrode can be suppressed by filling the glass frit 61 using the pressure difference, it is possible to maintain the airtightness of the cavity in a more favorable state compared to the related art.

### Oscillator

Next, an oscillator according to another embodiment of the invention will be described with reference to FIG. 16.

In an oscillator 110 according to the present embodiment, the piezoelectric vibrator 1 is used as an oscillating piece electrically connected to an integrated circuit 111, as shown in FIG. 16. The oscillator 110 includes a substrate 113 on which an electronic component 112, such as a capacitor, is mounted. The integrated circuit 111 for an oscillator is mounted on the substrate 113, and the piezoelectric vibrating reed of the piezoelectric vibrator 1 is mounted near the integrated circuit 111. The electronic component 112, the integrated circuit 111, and the piezoelectric vibrator 1 are electrically connected to each other by a wiring pattern (not shown). In addition, each of the constituent components is molded with a resin (not shown).

In the oscillator 110 configured as described above, when a voltage is applied to the piezoelectric vibrator 1, the piezoelectric vibrating reed in the piezoelectric vibrator 1 vibrates. This vibration is converted into an electrical signal due to the piezoelectric property of the piezoelectric vibrating reed and is then input to the integrated circuit 111 as the electrical signal. The input electrical signal is subjected to various kinds of processing by the integrated circuit 111 and is then output as a frequency signal. In this way, the piezoelectric vibrator 1 functions as an oscillating piece.

Moreover, by selectively setting the configuration of the integrated circuit 111, for example, an RTC (real time clock) module, according to the demands, it is possible to add a function of controlling the operation date or time of the corresponding device or an external device or of providing the time or calendar in addition to a single functional oscillator for a timepiece.

As described above, since the oscillator 110 according to the present embodiment includes the piezoelectric vibrator 1 which is manufactured by a low-cost manufacturing method capable of securing reliable conduction of the penetration electrode while maintaining the airtightness of the cavity, the oscillator 110 having excellent performance and superior reliability can be provided at a low cost.

### Electronic Apparatus

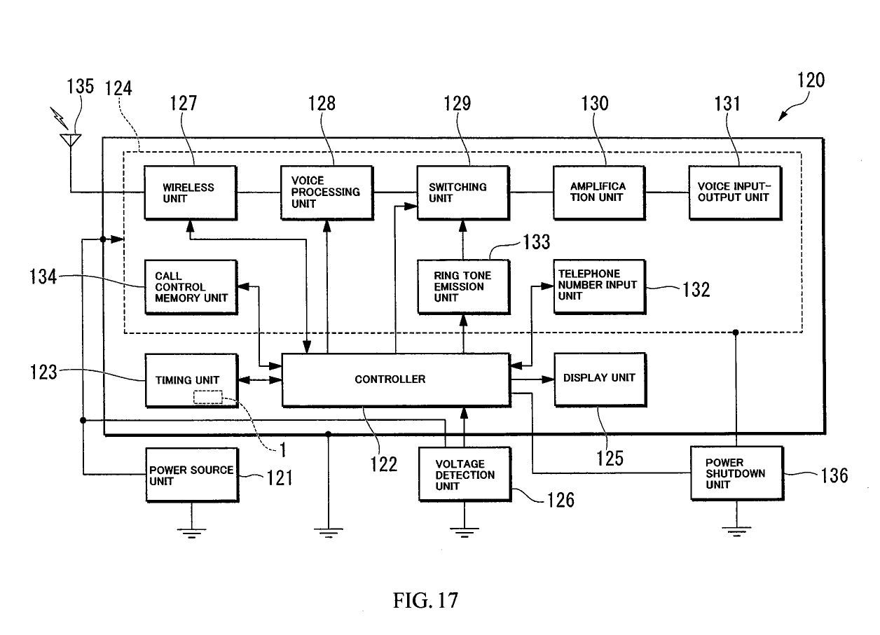

Next, an electronic apparatus according to another embodiment of the invention will be described with reference to FIG. 17. In addition, a portable information device 120 including the piezoelectric vibrator 1 will be described as an example of an electronic apparatus.

The portable information device 120 according to the present embodiment is represented by a mobile phone, for example, and has been developed and improved from a wristwatch in the related art. The portable information device 120 is similar to a wristwatch in external appearance, and a liquid crystal display is disposed in a portion equivalent to a dial pad so that a current time and the like can be displayed on this screen. Moreover, when it is used as a communication apparatus, it is possible to remove it from the wrist and to perform the same communication as a mobile phone in the related art with a speaker and a microphone built in an inner portion of the band. However, the portable information device 120 is very small and light compared with a mobile phone in the related art.

Next, the configuration of the portable information device 120 according to the present embodiment will be described. As shown in FIG. 17, the portable information device 120 includes the piezoelectric vibrator 1 and a power supply section 121 for supplying power. The power supply section 121 is formed of a lithium secondary battery, for example. A control section 122 which performs various kinds of control, a clock section 123 which performs counting of time and the like, a communication section 124 which performs communication with the outside, a display section 125 which displays various kinds of information, and a voltage detecting section 126 which detects the voltage of each functional section are connected in parallel to the power supply section 121. In addition, the power supply section 121 supplies power to each functional section.

The control section 122 controls an operation of the entire system. For example, the control section 122 controls each functional section to transmit and receive the audio data or to measure or display a current time. In addition, the control section 122 includes a ROM in which a program is written in advance, a CPU which reads and executes a program written in the ROM, a RAM used as a work area of the CPU, and the like.

The clock section 123 includes an integrated circuit, which has an oscillation circuit, a register circuit, a counter circuit, and an interface circuit therein, and the piezoelectric vibrator 1. When a voltage is applied to the piezoelectric vibrator 1, the piezoelectric vibrating reed vibrates, and this vibration is converted into an electrical signal due to the piezoelectric property of crystal and is then input to the oscillation circuit as the electrical signal. The output of the oscillation circuit is binarized to be counted by the register circuit and the counter circuit. Then, a signal is transmitted to or received from the control section 122 through the interface circuit, and current time, current date, calendar information, and the like are displayed on the display section 125.

The communication section 124 has the same function as a mobile phone in the related art, and includes a wireless section 127, an audio processing section 128, a switching section 129, an amplifier section 130, an audio input/output section 131, a telephone number input section 132, a ring tone generating section 133, and a call control memory section 134.

The wireless section 127 transmits/receives various kinds of data, such as audio data, to/from the base station through an antenna 135. The audio processing section 128 encodes and decodes an audio signal input from the wireless section 127 or the amplifier section 130. The amplifier section 130 amplifies a signal input from the audio processing section 128 or the audio input/output section 131 up to a predetermined level. The audio input/output section 131 is formed by a speaker, a microphone, and the like, and amplifies a ring tone or incoming sound loudly or collects the sound.

In addition, the ring tone generating section 133 generates a ring tone in response to a call from the base station. The switching section 129 switches the amplifier section 130, which is connected to the audio processing section 128, to the ring tone generating section 133 only when a call arrives, so that the ring tone generated in the ring tone generating section 133 is output to the audio input/output section 131 through the amplifier section 130.

In addition, the call control memory section 134 stores a program related to incoming and outgoing call control for communications. Moreover, the telephone number input section 132 includes, for example, numeric keys from 0 to 9 and other keys. The user inputs a telephone number of a communication destination by pressing these numeric keys and the like.

The voltage detecting section 126 detects a voltage drop when a voltage, which is applied from the power supply section 121 to each functional section, such as the control section 122, drops below the predetermined value, and notifies the control section 122 of the detection. In this case, the predetermined voltage value is a value which is set beforehand as the lowest voltage necessary to operate the communication section 124 stably. For example, it is about 3 V. When the voltage drop is notified from the voltage detecting section 126, the control section 122 disables the operation of the wireless section 127, the audio processing section 128, the switching section 129, and the ring tone generating section 133. In particular, the operation of the wireless section 127 that consumes a large amount of power should be necessarily stopped. In addition, a message informing that the communication section 124 is not available due to insufficient battery power is displayed on the display section 125.

That is, it is possible to disable the operation of the communication section 124 and display the notice on the display section 125 by the voltage detecting section 126 and the control section 122. This message may be a character message. Or as a more intuitive indication, a cross mark (X) may be displayed on a telephone icon displayed at the top of the display screen of the display section 125.

In addition, the function of the communication section 124 can be more reliably stopped by providing a power shutdown section 136 capable of selectively shutting down the power of a section related to the function of the communication section 124.

As described above, since the portable information device 120 according to the present embodiment includes the piezoelectric vibrator 1 which is manufactured by a low-cost manufacturing method capable of securing reliable conduction of the penetration electrode while maintaining the airtightness of the cavity, the portable information device 120 having excellent performance and superior reliability can be provided at a low cost.

### Radio-Controlled Timepiece

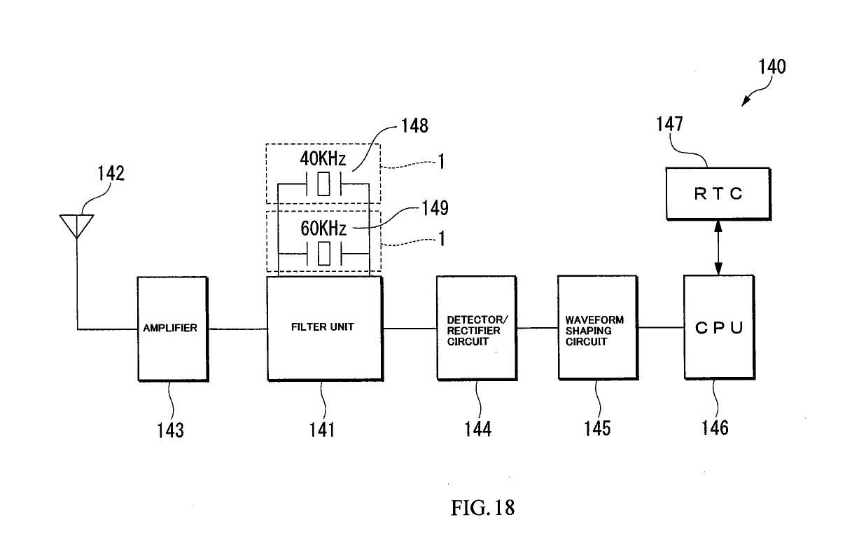

Next, a radio-controlled timepiece according to still another embodiment of the invention will be described with reference to FIG. 18.

As shown in FIG. 18, a radio-controlled timepiece 140 according to the present embodiment includes the piezoelectric vibrators 1 electrically connected to a filter section 141. The radio-controlled timepiece 140 is a timepiece with a function of receiving a standard radio wave including the clock information, automatically changing it to the correct time, and displaying the correct time.

In Japan, there are transmission centers (transmission stations) that transmit a standard radio wave in Fukushima Prefecture (40 kHz) and Saga Prefecture (60 kHz), and each center transmits the standard radio wave. A long wave with a frequency of, for example, 40 kHz or 60 kHz has both a characteristic of propagating along the land surface and a characteristic of propagating while being reflected between the ionospheric layer and the land surface, and therefore has a propagation range wide enough to cover the entire area of Japan through the two transmission centers.

Hereinafter, the functional configuration of the radio-controlled timepiece 140 will be described in detail.

An antenna 142 receives a long standard radio wave with a frequency of 40 kHz or 60 kHz. The long standard radio wave is obtained by performing AM modulation of the time information, which is called a time code, using a carrier wave with a frequency of 40 kHz or 60 kHz. The received long standard wave is amplified by an amplifier 143 and is then filtered and synchronized by the filter section 141 having the plurality of piezoelectric vibrators 1.

In the present embodiment, the piezoelectric vibrators 1 include crystal vibrator sections 148 and 149 having resonance frequencies of 40 kHz and 60 kHz, respectively, which are the same frequencies as the carrier frequency.

In addition, the filtered signal with a predetermined frequency is detected and demodulated by a detection and rectification circuit 144.

Then, the time code is extracted by a waveform shaping circuit 145 and counted by the CPU 146. The CPU 146 reads the information including the current year, the total number of days, the day of the week, the time, and the like. The read information is reflected on an RTC 148, and the correct time information is displayed.

Because the carrier wave is 40 kHz or 60 kHz, a vibrator having the tuning fork structure described above is suitable for the crystal vibrator sections 148 and 149.

Moreover, although the above explanation has been given for the case in Japan, the frequency of a long standard wave is different in other countries. For example, a standard wave of 77.5 kHz is used in Germany. Therefore, when the radio-controlled timepiece 140 which is also operable in other countries is assembled in a portable device, the piezoelectric vibrator 1 corresponding to frequencies different from the frequencies used in Japan is necessary.

As described above, since the radio-controlled timepiece 140 according to the present embodiment includes the piezoelectric vibrator 1 which is manufactured by a low-cost manufacturing method capable of securing reliable conduction of the penetration electrode while maintaining the airtightness of the cavity, the radio-controlled timepiece 140 having excellent performance and superior reliability can be provided at a low cost.

The present invention is not limited to the above-described embodiments.

In the present embodiment, a piezoelectric vibrator was manufactured by sealing a piezoelectric vibrating reed in a package using the method of manufacturing a package according to the present invention. However, a device other than the piezoelectric vibrator may be manufactured by sealing an electronic component other than the piezoelectric vibrating reed in a package.

In the present embodiment, the method of manufacturing a package according to the present invention has been described by way of an example of a piezoelectric vibrator using, for example, a tuning-fork type piezoelectric vibrating reed. However, the method of manufacturing a package according to the present invention may be applied to a piezoelectric vibrator using an AT-cut type piezoelectric vibrating reed (a thickness-shear type vibrating reed).

In the present embodiment, the penetration hole is formed on the base substrate wafer 40, and the metal pin standing up from the base portion is disposed in the penetration hole. However, a bottomed recess portion may be formed on the base substrate wafer 40, and the metal pin may be disposed in the recess portion. In this way, since the step of removing the base portion is not necessary, it is possible to simplify the polishing step. However, the present embodiment is superior in that the metal pin can be disposed without being tilted in the penetration hole by disposing the metal pin while bringing the base portion into contact with the second surface.

What is claimed is:

1. A method for producing piezoelectric vibrators, comprising:
(a) defining a plurality of first substrates on a first wafer and a plurality of second substrates on a second wafer;
(b) forming a pair of through-holes in a respective at least some of the first substrates on the first wafer;
(c) inserting a conductive pin in a respective at least some of the through-holes; and
(d) pushing filler by means of an air pressure in at least some of the through-holes in which the conductive pins are inserted.

2. The method according to claim 1, further comprising:
(e) hermetically bonding the first and second wafers such that at least some of the first substrates substantially coincide respectively with at least some of the corresponding second substrates, wherein a piezoelectric vibrating reed is secured in a respective at least some of coinciding first and second substrates; and
(f) cutting off a respective at least some of packages formed of the hermetically bonded first and second substrates.

3. The method according to claim 1, wherein forming a pair of through-holes comprises pressing a die with a plurality projections onto the first wafer to form holes in the first ware and grinding one surface of the first wafer to expose the holes through the one surface of the first wafer.

4. The method according to claim 3, wherein the through-holes has cross-sections which become smaller towards the one surface of the first wafer from the other surface thereof.

5. The method according to claim 1, wherein the conductive pin is connected with a planar head larger than one end of the through-hole.

6. The method according to claim 1, wherein pushing filler comprises closing one end of a respective at least some of the through-holes in which the conductive pins are inserted.

7. The method according to claim 6, wherein closing one end comprises applying a removable tape to cover the one end.

8. The method according to claim 6, wherein pushing filler comprises applying the filler in a film shape to close the other end of a respective at least some of the through-holes whose one ends are closed.

9. The method according to claim 8, wherein applying the filler in a film shape comprises applying the filler in a film shape in a low air pressure atmosphere.

10. The method according to claim 8, wherein applying the filler in a film shape comprises:
placing on the first wafer a mask formed with holes exposing at least some of the through-holes formed in the first wafer; and
squeegeeing the filler over the mask to form films of filler in at least some of the holes.

11. The method according to claim 10, wherein squeegeeing the filler comprises squeegeeing the filler at an attack angle of about 60 degrees to about 70 degrees.

12. The method according to claim 10, wherein the mask has a thickness of about 0.1 mm to 0.2 mm.

13. The method according to claim 8, wherein pushing filler comprises subjecting the first wafer to a air pressure higher than an air pressure inside the closed through-holes to thereby suck the films of filler in the through-holes.

14. The method according to claim 13, further comprising:
drying the filler in the through-holes; and
baking the first wafer to harden the filler in the through-holes.

15. The method according to claim 1, wherein the filler is glass frit.

16. The method according to claim 14, further comprising polishing at least one surface of the first wafer to expose both ends of the conductive pins from the surfaces of the first wafer.
